(19) United States
(12) Patent Application Publication
(10) Pub. No.: US 2011/0135364 A1
(43) Pub. Date: Jun. 9, 2011

(54) IMAGE FORMING APPARATUS

(75) Inventor: Noriyuki TAKUWA, Kanagawa-ken (JP)

(73) Assignees: Kabushiki Kaisha Toshiba, Tokyo (JP); Toshiba Tec Kabushiki Kaisha, Tokyo (JP)

(21) Appl. No.: 12/958,753

(22) Filed: Dec. 2, 2010

Related U.S. Application Data
(60) Provisional application No. 61/266,638, filed on Dec. 4, 2009.

(51) Int. Cl. G03G 15/00

(52) U.S. Cl. 399/405

(57) ABSTRACT

According to one embodiment, an image forming apparatus includes: an image forming unit configured to form a toner image on a sheet; a paper feeding cassette configured to store sheets to be supplied to the image forming unit; a case configured to house the image forming unit and the paper feeding cassette; a scanner provided in an upper part of the case, shifted with respect to an area surrounded by sides of the case, and configured to read an image of an original document; a second connecting section provided in an upper part of the case, which is an area of the area surrounded by sides of the case where the scanner is not located, and connected to a first connecting section provided on a bottom surface of a paper discharging apparatus that receives a sheet from the image forming unit; and a discharging unit configured to discharge the sheet from the image forming unit to a conveying path of the paper discharging apparatus when the first connecting section and the second connecting section are connected.

### CROSS-REFERENCE TO RELATED APPLICATION

This application is also based upon and claims the benefit of priority from U.S. provisional application 61/266638, filed on Dec. 4, 2009; the entire contents of which are incorporated herein by reference.

### FIELD

Embodiments described herein relate generally to an image forming apparatus to which a paper discharging apparatus is connected.

### BACKGROUND

A paper discharging apparatus is set side by side with an image forming apparatus on a floor surface. The image forming apparatus sends a sheet to the paper discharging apparatus after forming an image on the sheet. The paper discharging apparatus stacks the sheet sent from the image forming apparatus on a tray.

If there is unevenness on the floor surface on which the image forming apparatus and the paper discharging apparatus are set, it is likely that steps are formed on a path for conveying the sheet from the image forming apparatus to the paper discharging apparatus and a jam occurs.

### DESCRIPTION OF THE DRAWINGS

FIG. 1 is a schematic diagram of an image forming apparatus according to a first embodiment;

FIG. 2 is a diagram of the image forming apparatus viewed from a floor surface;

FIG. 3 is a schematic diagram of an image processing system according to the first embodiment;

FIG. 4 is an enlarged view of a connecting portion of the image forming apparatus and a paper discharging apparatus;

FIG. 5 is a schematic diagram of an image forming apparatus according to a second embodiment;

FIG. 6 is an external view of the image forming apparatus according to the second embodiment;

FIG. 7 is a schematic diagram of an image forming system according to the second embodiment; and

FIG. 8 is an enlarged view of a portion of the image forming apparatus according to the second embodiment connected to a paper discharging apparatus.

### DETAILED DESCRIPTION

In general, according to one embodiment, an image forming apparatus includes: an image forming unit configured to form a toner image on a sheet; a paper feeding cassette configured to store sheets to be supplied to the image forming unit; a case configured to house the image forming unit and the paper feeding cassette; a scanner provided in an upper part of the case, shifted with respect to an area surrounded by sides of the case, and configured to read an image of an original document; a second connecting section provided in an upper part of the case, which is an area of the area surrounded by sides of the case where the scanner is not located, and connected to a first connecting section provided on a bottom surface of a paper discharging apparatus that receives a sheet from the image forming unit; and a discharging unit configured to discharge the sheet from the image forming unit to a conveying path of the paper discharging apparatus when the first connecting section and the second connecting section are connected.

### First Embodiment

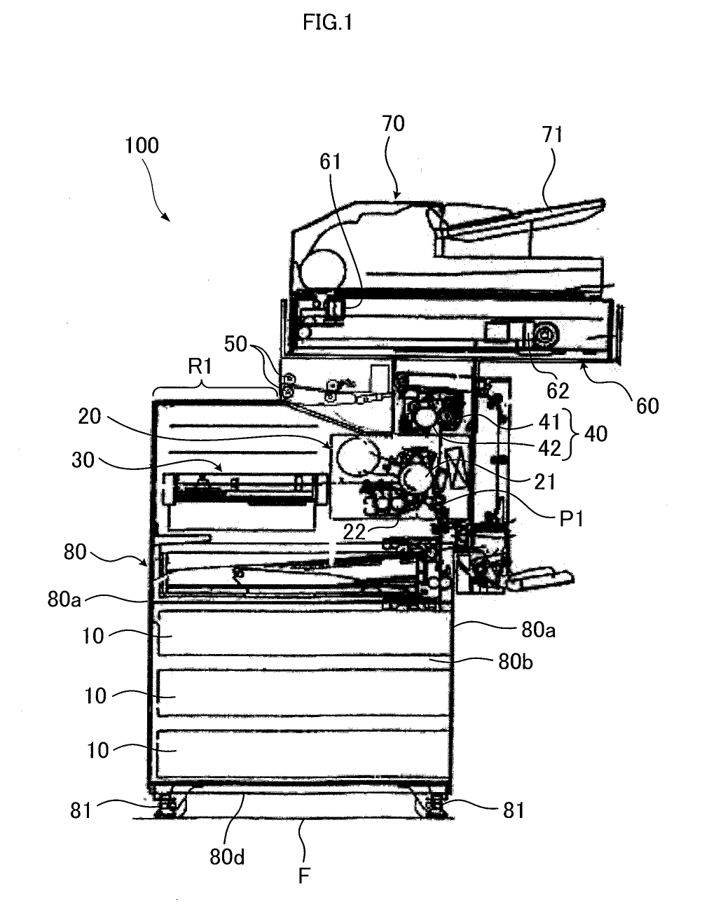

An image processing system according to a first embodiment is explained below with reference to the accompanying drawings. FIG. 1 is a schematic diagram of an image forming apparatus. The internal structure of a part of the image forming apparatus is also shown. An image forming apparatus 100 discharges a sheet after forming an image on the sheet.

The image forming apparatus 100 includes plural paper feeding cassettes 10. The plural paper feeding cassettes 10 are arranged side by side in the vertical direction of the image forming apparatus 100. The number of the paper feeding cassettes 10 can be set as appropriate.

Each of the paper feeding cassettes 10 stores plural sheets. The sheets stored in the paper feeding cassettes 10 are conveyed one by one along a conveying path P1 in the image forming apparatus 100. The sheet reaches an image forming unit 20. The image forming unit 20 transfers a developer image formed on a photoconductive drum 21 onto the sheet. The developer image is formed on the photoconductive drum 21 on the basis of image data generated by a reading operation of a scanner 60 explained later or image data transmitted from an external apparatus (e.g., a personal computer) to the image forming apparatus 100.

An exposure unit 30 irradiates a laser beam on the photoconductive drum 21 to thereby form an electrostatic latent image on the surface of the photoconductive drum 21. A developing device 22 supplies a developer to the surface of the photoconductive drum 21 to thereby form a developer image on the surface of the photoconductive drum 21. The photoconductive drum 21 transfers the developer image onto the sheet supplied from the paper feeding cassettes 10.

The sheet having the developer image formed thereon is conveyed to a fixing device 40. The fixing device 40 applies heat to the sheet to thereby fix the developer image on the sheet. The fixing device 40 includes a heating roller 41 configured to apply heat to the sheet and a pressing roller 42 configured to press the sheet against the heating roller 41. The fixing device 40 only has to be capable of heating the sheet having the developer image formed thereon.

The sheet passed through the fixing device 40 is conveyed along a conveying path in the image forming apparatus 100. Paper discharge rollers 50 discharge the sheet to the outside of the image forming apparatus 100. The paper discharge rollers 50 discharge the sheet in the horizontal direction.

The scanner 60 is provided in an upper part of the image forming apparatus 100. The scanner 60 scans and reads an image of an original document. Specifically, a carriage 61 including a light source moves in the direction of an arrow D shown in FIG. 1 to thereby irradiate light on the original document. An imaging element 62 in the scanner 60 receives reflected light from the original document to thereby generate image data corresponding to the image of the original document. The image forming unit 20 forms the image on a sheet on the basis of the image data generated by the scanner 60.

A case 80 is an armor of the image forming apparatus 100. The case 80 houses the paper feeding cassettes 10, the image forming unit 20, the exposure unit 30, and the fixing device 40. The case 80 has two sides 80a, a front surface 80b from which the paper feeding cassettes 10 are drawn out, a rear surface 80c, and a bottom surface 80d.

Four legs 81 are provided on the bottom surface of the image forming apparatus 100. The legs 81 are set in contact with a floor surface F and separate the bottom surface of the image forming apparatus 100 from the floor surface F.

An apparatus (ADF: Auto Document Feeder) 70 that automatically conveys an original document to the scanner 60 is provided above the scanner 60. The ADF 70 has a tray 71 on which the original document is placed. When the image forming apparatus 100 is viewed from above, the ADF 70 and the scanner 60 overlap each other. The ADF 70 can be omitted.

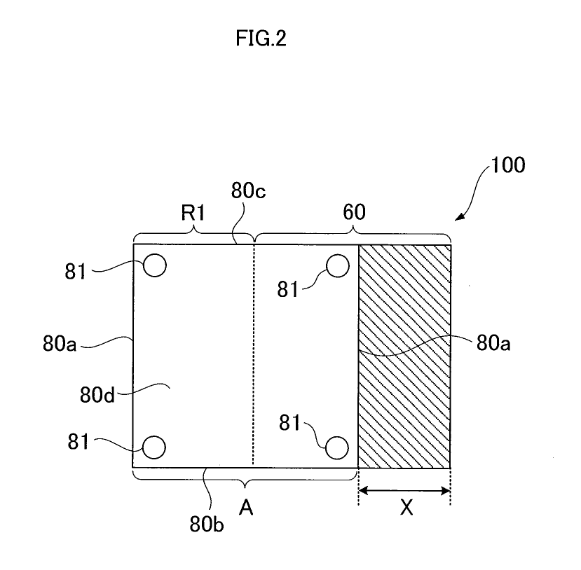

The scanner 60 and the ADF 70 are shifted in the horizontal direction with respect to the paper feeding cassettes 10 and the image forming unit 20. Specifically, as shown in FIG. 2, when the image forming apparatus 100 is viewed from the floor surface F, the scanner 60 is shifted in one direction (a right direction in FIG. 2) with respect to an area A where the paper feeding cassettes 10 and the image forming unit 20 are provided. A shifting amount X of the scanner 60 can be set as appropriate.

The four legs 81 are provided at four corners of the area A. The legs 81 separate the bottom surface of the case 80 from the floor surface F.

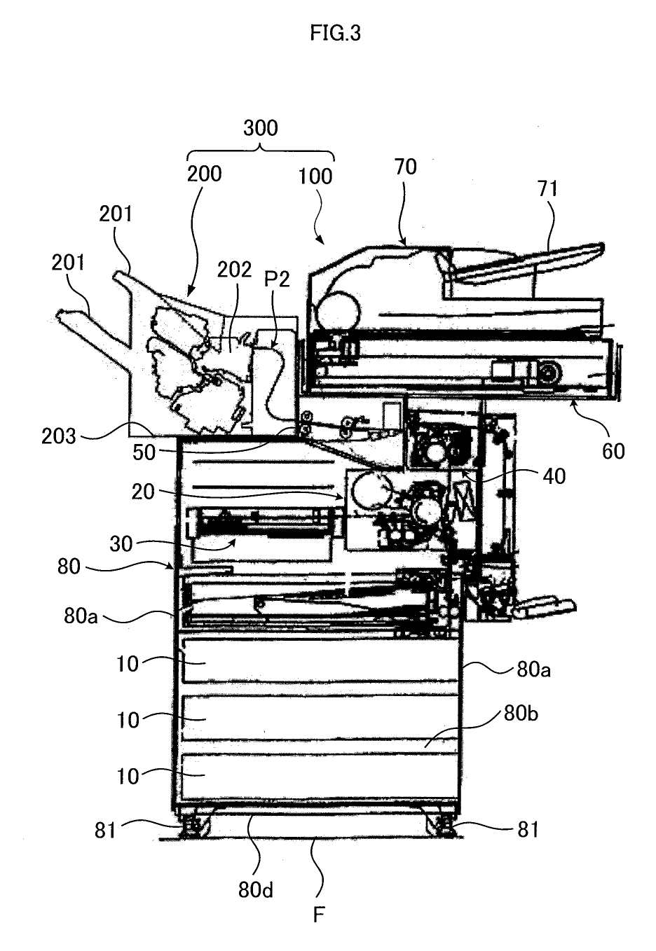

The upper surface of the image forming apparatus 100 has a section (hereinafter referred to as supporting area) R1 on which a paper discharging apparatus 200 (see FIG. 3) is placed. A part of the exposure unit 30 and a part of the paper feeding cassettes 10 are present below the supporting area R1. When the image forming apparatus 100 is viewed from above, the supporting area R1 and the scanner 60 (including the ADF 70) are arranged side by side in the horizontal direction. The supporting area R1 is present below the paper discharge rollers 50. The paper discharge rollers 50 discharge a sheet to a space above the supporting area R1.

FIG. 3 is a schematic diagram of an image processing system 300. The internal structures of a part of the image forming apparatus 100 and the paper discharging apparatus 200 are shown. The image processing system 300 includes the image forming apparatus 100 and the paper discharging apparatus 200 placed on the image forming apparatus 100.

A bottom surface section 203 of the paper discharging apparatus 200 is in contact with the supporting area R1 of the image forming apparatus 100. The supporting area R1 is in contact with a half or more of the area of the bottom surface section 203 of the paper discharging apparatus 200. Even if the paper discharging apparatus 200 is placed on the supporting area R1, the paper discharging apparatus 200 does not fall from the supporting area R1.

The paper discharging apparatus 200 receives sheets from the image forming apparatus 100 and stacks the sheets on trays 201. The trays 201 are provided on the opposite side of the side of the scanner 60 in the paper discharging apparatus 200. The paper discharging apparatus 200 includes two trays 201. The two trays 201 are arranged side by side in the vertical direction of the paper discharging apparatus 200. The number of the trays 201 can be set as appropriate.

The paper discharging apparatus 200 includes a stapler 202. The stapler 202 applies stapling to sheets from the image forming apparatus 100. The stapler 202 can be omitted. The paper discharging apparatus 200 can perform other kinds of processing except the stapling.

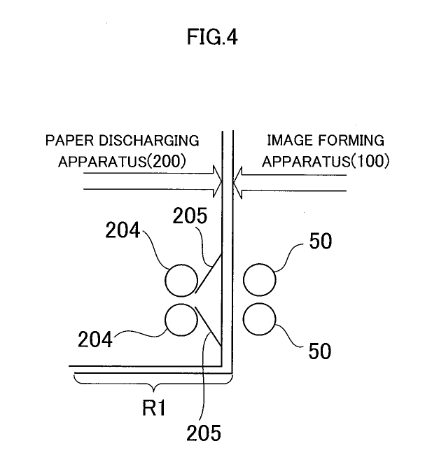

As shown in FIG. 4, the paper discharging apparatus 200 includes conveying rollers 204. The conveying rollers 204 receive a sheet discharged from the paper discharge rollers 50 of the image forming apparatus 100. The paper discharging apparatus 200 includes guide members 205. The guide members 205 have slopes opening to the side of the paper discharge rollers 50 and guide the sheet from the paper discharge rollers 50 to a nip section of the conveying rollers 204. The guide members 205 can be omitted.

The sheet fed into the paper discharging apparatus 200 is conveyed along a conveying path P2. The conveying path P2 extends upward while bending. When the paper discharging apparatus 200 is viewed from above, portions of the conveying path P2 overlap one another.

According to this embodiment, since the paper discharging apparatus 200 is placed on the supporting area R1 of the image forming apparatus 100, the paper discharging apparatus 200 can be positioned on the image forming apparatus 100 and can be separated from the floor surface F. Even if the floor surface F has unevenness, the paper discharging apparatus 200 and the image forming apparatus 100 are not shifted from each other because of the unevenness.

Since the scanner 60 and the paper discharging apparatus 200 are arranged side by side in the horizontal direction, operability of the scanner 60 and the paper discharging apparatus 200 can be improved. Specifically, the scanner 60 can be operated and sheets stacked on the tray 201 of the paper discharging apparatus 200 can be extracted at the same height.

In this embodiment, the supporting area R1 is formed by a flat surface. However, pins projecting upward from the supporting area R1 can be provided. The paper discharging apparatus 200 can be positioned with respect to the supporting area R1 by using the pins. Specifically, grooves into which the pins are inserted can be provided in the paper discharging apparatus 200. The pins only have to be capable of positioning the paper discharging apparatus 200 in the supporting area R1. The pins can be provided on, for example, a side where a sheet is discharged from the paper discharge rollers 50 rather than in the supporting area R1. On the other hand, the pins can be provided in the paper discharging apparatus 200 and the grooves into which the pins are inserted can be provided in the supporting area R1.

Not only the structure of the pins and the grooves, a structure (a first connecting section and a second connecting section) that can position the paper discharging apparatus 200 in the supporting area R1 can be used. Specifically, engaging sections that engage with each other can be provided in the paper discharging apparatus 200 and the supporting area R1. As the engaging sections, for example, pawls can be used. The paper discharging apparatus 200 can also be positioned in the supporting area R1 by providing a vertical wall at an edge of the supporting area R1 and setting the vertical wall in contact with a side of the paper discharging apparatus 200.

In this embodiment, the four legs 81 are present in the area A. However, the legs 81 can be arranged in positions on the outside of the area A. Specifically, arms extending to the outer side of the area A can be provided and the legs 81 can be provided at the distal ends of the arms. Even if the legs 81 are arranged in the positions on the outside of the area A, the image forming apparatus 100 can be supported on the floor surface F by the legs 81.

The paper discharging apparatus 200 can be electrically connected to the image forming apparatus 100. Specifically, connectors for electrical connection can be respectively provided in areas where the paper discharging apparatus 200 and the image forming apparatus 100 are opposed to each other when the paper discharging apparatus 200 is placed on the supporting area R1. For example, the connectors can be provided on the bottom surface of the paper discharging apparatus 200 and the connectors can be provided in the supporting area R1.

### Second Embodiment

An image processing system according to a second embodiment is explained with reference to the accompanying drawings. Members having functions same as those of the members explained in the first embodiment are denoted by the same reference numerals and signs.

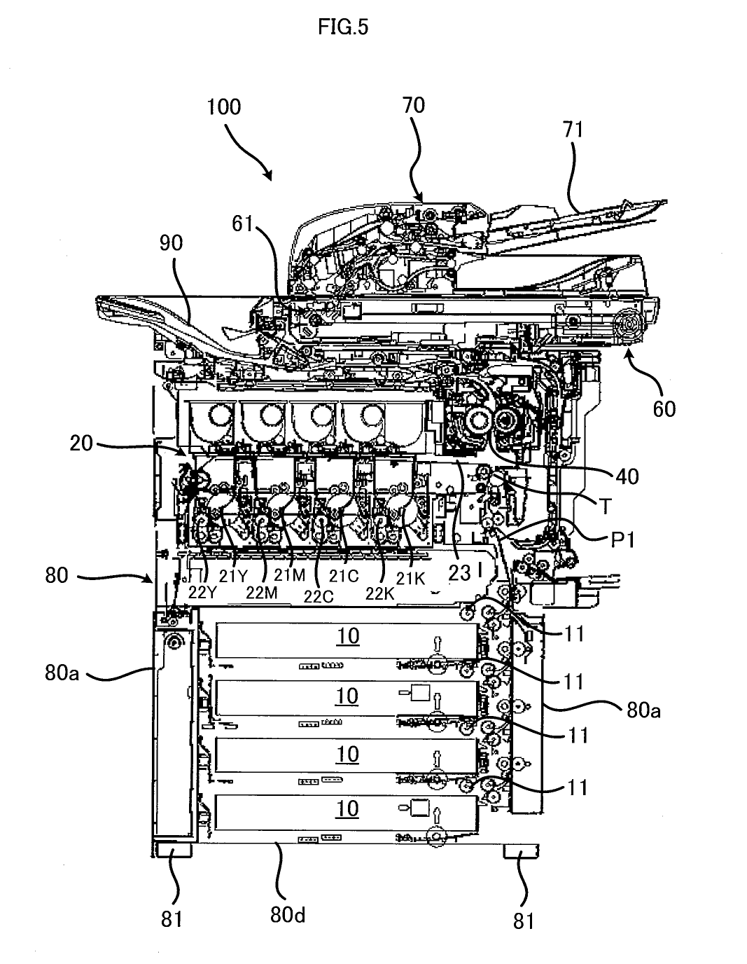

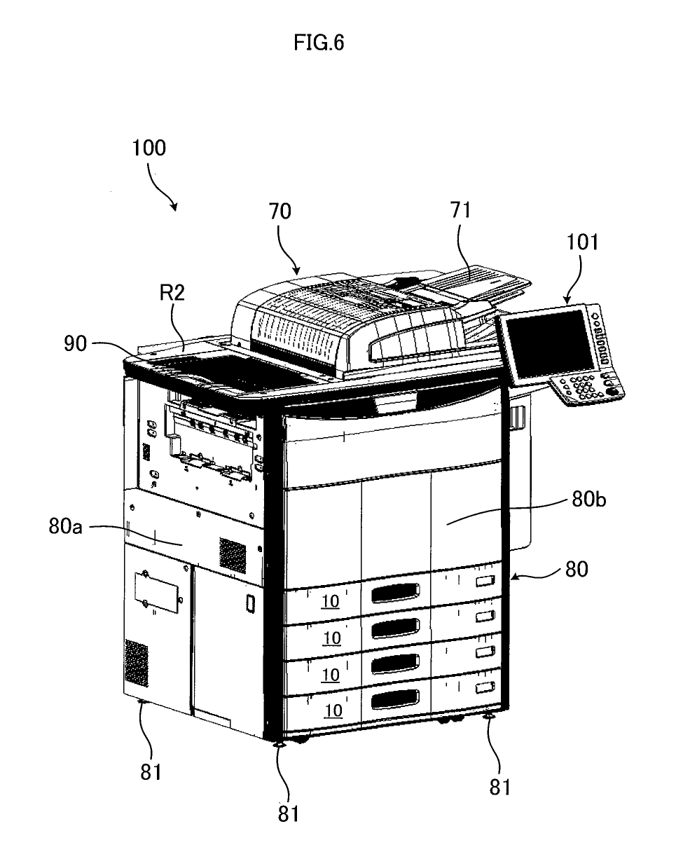

FIG. 5 is a diagram of the internal structure of the image forming apparatus 100. FIG. 6 is an external view of the image forming apparatus 100.

Pickup rollers 11 separate sheets stored in the paper feeding cassettes 10 one by one and feed the sheet to the conveying path P1. The sheet is conveyed along the conveying path P1.

The image forming unit 20 includes photoconductive drums 21Y, 21M, 21C, and 21K. The photoconductive drums 21Y to 21K are used in order to transfer developer images of yellow (Y), magenta (M), cyan (C), and black (K) onto an intermediate transfer belt 23. Electrostatic latent images are formed on the surfaces of the photoconductive drums 21Y to 21K by irradiation of laser beams.

Developing rollers (so-calledmag-rollers) 22Y, 22M, 22C, and 22K supply developers to the photoconductive drums 21Y to 21K having the electrostatic latent images formed thereon. The developing rollers 22Y to 22K respectively correspond to the photoconductive drums 21Y to 21K. The electrostatic latent images formed on the photoconductive drums 21Y to 21K are visualized by the supply of the developers.

The photoconductive drums 21Y to 21K transfer the developer images onto the intermediate transfer belt 23. After being moved to a secondary transfer position T by the rotation of the intermediate transfer belt 23, the developer images are transferred onto the sheet from the paper feeding cassettes 10.

The sheet having the developer images transferred thereon is conveyed to the fixing device 40. The fixing device 40 heats the sheet to thereby fix the developer images on the sheet. The sheet passed through the fixing device 40 is conveyed along a conveying path and discharged to a tray 90.

The tray 90 is formed on the upper surface of the image forming apparatus 100. When the image forming apparatus 100 is viewed from above, the tray 90 and the scanner 60 (including the ADF 70) are arranged side by side in the horizontal direction. A conveying path 91 for reversing the sheet is provided in a lower part of the tray 90.

An operation panel 101 is provided in the front of the image forming apparatus 100. The operation panel 101 includes a display unit and an input unit. The display unit displays predetermined information concerning processing of the image forming apparatus 100. As the display unit, for example, an LCD (Liquid Crystal Display), an EL (Electronic Luminescence), a PDP (Plasma Display Panel), or a CRT (Cathode Ray Tube) can be used. The input unit is used in order to input predetermined information to the image forming apparatus 100. As the input unit, for example, a keyboard, a mouse, a touch panel, a touchpad, or a graphics tablet can be used. On the other hand, the functions of the display unit and the input unit can also be realized by a so-called touch panel display.

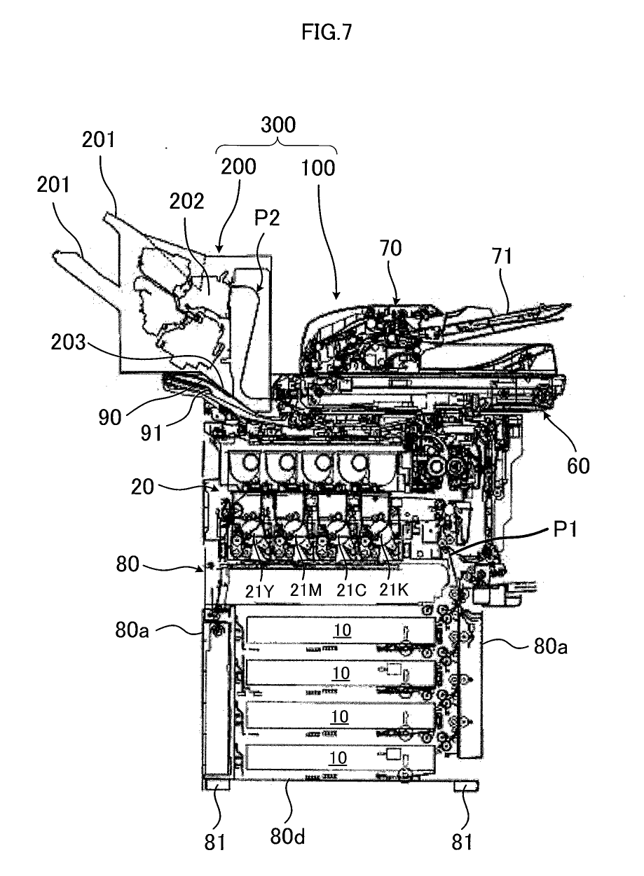

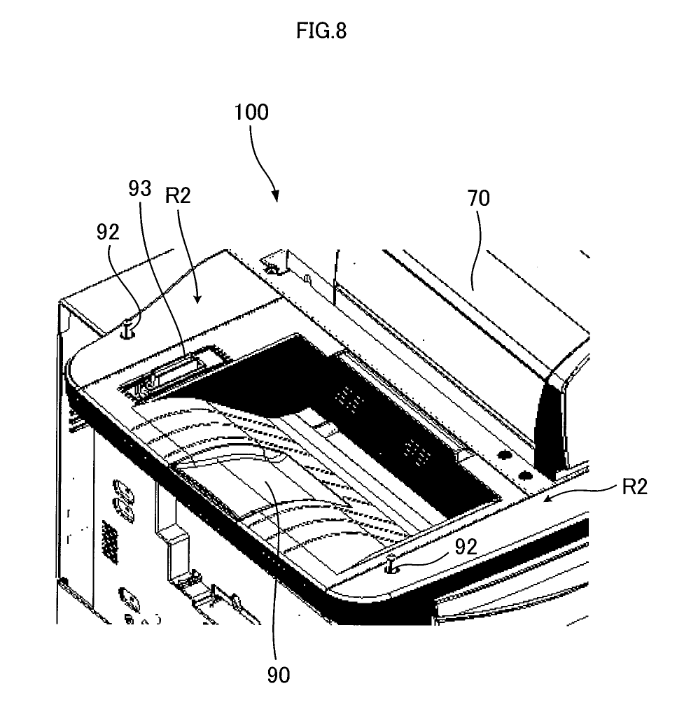

As shown in FIG. 7, the paper discharging apparatus 200 is placed on the image forming apparatus 100. As shown in FIG. 8, supporting areas R2 for placing the paper discharging apparatus 200 are present around the paper discharge tray 90.

When the image forming apparatus 100 is viewed from above, the supporting areas R2 are respectively provided in positions across the paper discharge tray 90. Specifically, the supporting areas R2 are respectively present on the front side and the rear side of the image forming apparatus 100 with respect to the paper discharge tray 90. The supporting areas R2 are present in the same plane as a document table glass of the scanner 60. When an image of an original document is read, the original document is placed on the document table glass.

When the paper discharging apparatus 200 is placed on the supporting areas R2, the paper discharge tray 90 is closed by the paper discharging apparatus 200.

As shown in FIG. 8, pins 92 and a connector 93 are present in the supporting areas R2. One pin 92 is present in one supporting area R2 of the two supporting areas R2 across the paper discharge tray 90. The other pin 92 and the connector 93 are present in the other supporting area R2.

The pins 92 are used in order to position the paper discharging apparatus 200 with respect to the supporting areas R2. The paper discharging apparatus 200 has grooves into which the pins 92 are inserted. When the paper discharging apparatus 200 is positioned in the supporting areas R2, a connector of the paper discharging apparatus 200 is connected to the connector 93 of the image forming apparatus 100. The connector of the paper discharging apparatus 200 is provided in the bottom surface section 203 of the paper discharging apparatus 200 and faces downward.

It is possible to perform communication between the paper discharging apparatus 200 and the image forming apparatus 100 by connecting the connector of the paper discharging apparatus 200 and the connector 93 of the image forming apparatus 100. Specifically, it is possible to supply electric power from the image forming apparatus 100 to the paper discharging apparatus 200 and transmit a control signal for causing the paper discharging apparatus 200 to operate.

The connector 93 is present between the two pins 92. In the paper discharging apparatus 200, the connector is present between the two grooves into which the two pins 92 are inserted. If the connector 93 is present between the two pins 92, it is possible to easily connect the connector of the paper discharging apparatus 200 to the connector 93 of the image forming apparatus 100 while positioning the paper discharging apparatus 200 using the two pins 92.

Since the connector 93 of the image forming apparatus 100 faces upward, it is possible to securely connect, with the own weight of the paper discharging apparatus 200, the connector of the paper discharging apparatus 200 and the connector 93 of the image forming apparatus 100.

A part of the bottom surface section 203 of the paper discharging apparatus 200 is in contact with the supporting areas R2. The other part of the bottom surface section 203 is formed in a shape along the paper discharge tray 90 as shown in FIG. 7. When the paper discharging apparatus 200 is placed on the supporting areas R2 of the image forming apparatus 100, a sheet discharged to the paper discharge tray 90 is led to the paper discharging apparatus 200 and conveyed along the conveying path P2. A structure for conveying the sheet from the image forming apparatus 100 to the paper discharging apparatus 200 is the same as the structure shown in FIG. 4.

In this embodiment, the two pins 92 are used. However, the number and the positions of the pins 92 can be set as appropriate. The connector 93 only has to be formed within an area in which the supporting areas R2 are present. The position of the connector 93 can be set as appropriate.

While certain embodiments have been described, these embodiments have been presented by way of example only, and are not intended to limit the scope of invention. Indeed, the novel apparatus and method described herein may be embodied in a variety of other forms; furthermore, various omissions, substitutions and changes in the form of the apparatus and method described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form a toner image on a sheet;
a paper feeding cassette configured to store sheets to be supplied to the image forming unit;
a case configured to house the image forming unit and the paper feeding cassette;
a scanner provided in an upper part of the case, shifted with respect to an area surrounded by sides of the case, and configured to read an image of an original document;
a second connecting section provided in an upper part of the case, which is an area of the area surrounded by sides of the case where the scanner is not located, and connected to a first connecting section provided on a bottom surface of a paper discharging apparatus that receives a sheet from the image forming unit; and
a discharging unit configured to discharge the sheet from the image forming unit to a conveying path of the paper discharging apparatus when the first connecting section and the second connecting section are connected.

2. The apparatus according to claim 1, wherein, when the first connecting section and the second connecting section are connected, the paper discharging apparatus is present in a position beside the scanner.

3. The apparatus according to claim 1, wherein the area where the second connecting section is provided is in contact with a part of the bottom surface of the paper discharging apparatus.

4. The apparatus according to claim 1, further comprising plural legs provided on a bottom surface of the case and supporting the bottom surface of the case in positions separated from a floor.

5. The apparatus according to claim 1, wherein the second connecting section is connected to the first connecting section and positions the paper discharging apparatus.

6. The apparatus according to claim 1, wherein the first connecting section is a groove and the second connecting section is a pin inserted into the groove.

7. The apparatus according to claim 6, wherein the pin projects upward from the area where the second connecting section is provided.

8. The apparatus according to claim 1, wherein the first connecting section is a pin and the second connecting section is a groove into which the pin is inserted.

9. The apparatus according to claim 1, further comprising a connector being present in the area where the second connecting section is provided and electrically connected to a connector of the paper discharging apparatus.

10. The apparatus according to claim 5, further comprising a connector provided between a pair of the second connecting sections and electrically connected to a connector of the paper discharging apparatus.

11. The apparatus according to claim 1, further comprising a tray provided in an upper part of the case, the sheet from the image forming unit being stacked on the tray when the first connecting section and the second connecting section are not connected.

12. The apparatus according to claim 11, wherein the area in contact with the bottom surface of the paper discharging apparatus is present in a position along an outer edge of the tray.

13. The apparatus according to claim 11, wherein, when the first connecting section and the second connecting section are connected, the tray is closed by the paper discharging apparatus.

14. The apparatus according to claim 1, wherein the discharging unit discharges a sheet from the image forming unit in a horizontal direction.

15. The apparatus according to claim 1, wherein the area in contact with the bottom surface of the paper discharging apparatus is present within a same surface as a surface of the scanner on which an original document is placed.

16. An image processing system comprising:
a paper discharging apparatus including:
a tray on which a sheet is stacked;
a conveying path configured to conveying the sheet to the tray; and
a first connecting section provided on a bottom surface of the paper discharging apparatus; and
an image forming apparatus including:
an image forming unit configured to form a toner image on a sheet;
a paper feeding cassette configured to store sheets to be supplied to the image forming unit;
a case configured to house the image forming unit and the paper feeding cassette;
a scanner provided in an upper part of the case, shifted with respect to an area surrounded by sides of the case, and configured to read an image of an original document;
a second connecting section provided in an upper part of the case, which is an area of the area surrounded by sides of the case where the scanner is not located, and connected to the first connecting section; and
a discharging unit configured to discharge the sheet from the image forming unit to the conveying path of the paper discharging apparatus when the first connecting section and the second connecting section are connected.

17. The system according to claim 16, wherein
the image forming apparatus has a connector in the area where the second connecting section is provided, and
the paper discharging apparatus has a connector provided on the bottom surface thereof and electrically connected to the connector of the image forming apparatus.

18. The system according to claim 17, wherein
the connector of the paper discharging apparatus is present between a pair of the first connecting sections, and
the connector of the image forming apparatus is present between a pair of the second connecting sections.

19. The system according to claim 16, wherein
the image forming apparatus has a tray provided in an upper part of the case, the sheet from the image forming unit being stacked on the tray when the first connecting section and the second connecting section are not connected, and
the bottom surface of the paper discharging apparatus has a shape along the tray.

20. The system according to claim 16, wherein the discharging unit of the image forming apparatus moves the sheet from the image forming unit in a horizontal direction to thereby lead the sheet to the conveying path of the paper discharging apparatus.
